(19) United States
(12) Patent Application Publication
(10) Pub. No.: US 2023/0394400 A1
(43) Pub. Date: Dec. 7, 2023

(54) MACHINE LEARNING SYSTEM AND METHOD FOR SIMULATING SEQUENCE OF ACTIVITIES BASED ON WEATHER RISK

(71) Applicant: ORACLE INTERNATIONAL CORPORATION, Redwood Shores, CA (US)

(72) Inventors: Sharvari ADESH, Weston, FL (US); Lifang Sarah PAN, Philadelphia, PA (US)

(21) Appl. No.: 17/830,506

(22) Filed: Jun. 2, 2022

(51) Int. Cl. G06Q 10/06

(52) U.S. Cl. CPC G06Q 10/06313

(57) ABSTRACT

Systems, methods, and other embodiments associated with simulating sequences of activities based on weather risk are described. In one embodiment, a method includes receiving a sequence of activities and identifying a location and time periods for performing the activities. A machine learning model executed that is trained to predict weather conditions based on historical weather conditions and predict activities that are likely affected by the predicted weather conditions. Historical weather conditions are retrieved that are associated with the location and the time periods, and predicted weather conditions are generated. A performance of the sequence of activities is simulated and target activities that cannot be performed during the predicted weather conditions are identified. The target activities are replaced with different activities from the sequence of activities and a rearranged sequence of the activities is generated.

### BACKGROUND

Completing a project typically involves performing a number of activities. Some activities are dependent upon other factors and cannot be performed at any desired time due to a variety of risk factors. Activities may be dependent upon certain materials being available, resources being available, the completion of other activities, and/or weather conditions. For example, construction projects may be very large and complex. They can include many different activities and can last from 1 year to 5 years resulting in a significant spread for downturn risks, material shortages, labor issues, risk of supply chain failure, natural calamities, etc.

Prior systems have attempted to arrange activities in a workable manner or rely on input from user experiences. But they are not able to predict issues caused by unpredictable factors, which results in a less than desired outcome.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system associated with predicting and generating an optimized sequence of activities.

FIG. 2 illustrates one embodiment of a method associated with predicting and generating an optimized sequence of activities.

FIG. 3 illustrates one embodiment of an activity-weather matrix that maps activities to weather conditions.

FIG. 4 illustrates an embodiment of a graphical user interface showing a sequence of activities and recommendation for replacing an activity.

FIG. 5 illustrates another embodiment of a method associated with

predicting and generating recommendations for an optimized sequence of activities.

FIG. 6 illustrates an embodiment of a computing system configured with the example systems and/or methods disclosed.

### DETAILED DESCRIPTION

Systems and methods are described herein that provide a machine learning model and method for simulating or predicting a sequence of activities based on weather risk. In one embodiment, a machine learning (ML) model is trained to replace and/or rearrange a given sequence of activities based on historical data about activity types and the time of year the activities are scheduled to be performed. The machine learning (ML) model retrieves and incorporates historical weather data associated with the location where the activities are to be performed and the associated time of year (e.g., days/months).

The ML model may be trained to make predictions about the weather for upcoming days/weeks/months corresponding to scheduled days (time periods) of the activities and their location of performance. The ML model makes predictions about which activities will be impacted by weather and generates an optimized schedule that rearranges the sequence of activities and the scheduled time periods for the activities.

In one embodiment, the present system creates an activity database, for

example, configured as an activity-weather matrix. The activity-weather matrix maps construction activities to weather conditions that have associated condition thresholds. The activity-weather matrix is configured to indicate whether an associated activity can be performed or cannot be performed during certain types of weather conditions, such as when a weather condition threshold is met.

Historical weather conditions may be retrieved and automatically inputted to the system to predict weather risks. Based on predicted weather conditions for the location of the activities and the time periods, the present system may predict time delays and/or replace certain activities in the initial sequence with other activities based on weather risks.

For example, the prediction system, based on predicted lost working days, may generate recommendations by increasing the time duration of weather-sensitive activities (e.g., thus showing a time delay for completion). The system may also suggest adding more resources to finish such activities earlier than an initial end date and/or accommodating the non-working days into the schedule to cover for the workdays that will be potentially lost due to weather risks.

In another example, the prediction system may generate recommendations for replacing or swapping one or more activities in the initial sequence (that are likely affected by predicted weather) with other activities that are not likely affected by the predicted weather conditions at that time (e.g., indoor painting vs landscaping). Thus, for a construction project that includes an initial sequence of activities, an optimized schedule may be generated and suggested that includes a rearranged sequence of activities. In this manner, the rearranged sequence of activities is predicted to reduce weather risks and associated time delays for performing the construction project.

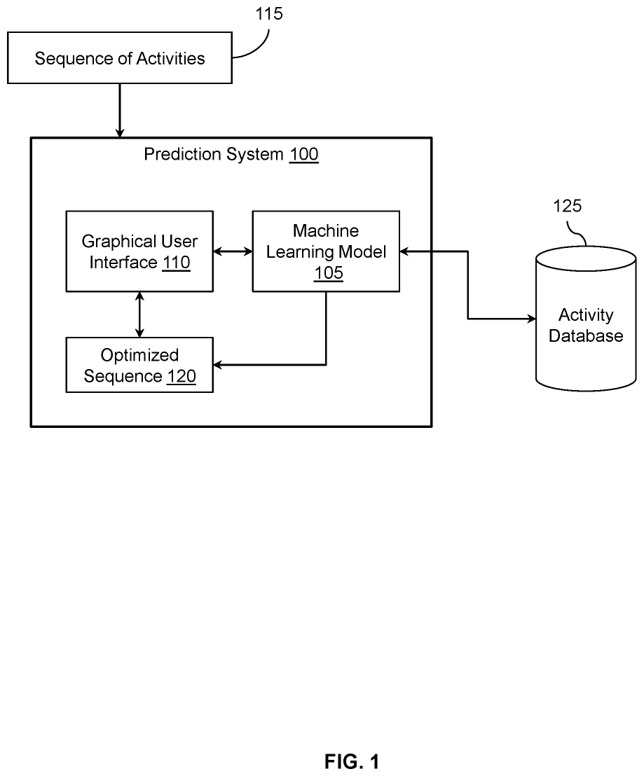

With reference to FIG. 1, one embodiment of a prediction system 100 is illustrated that is associated with simulating a sequence of activities based on weather risk and generating an optimize sequence of activities. The prediction system 100 is configured to automatically retrieve and input historical weather data associated with the location and time periods that the sequence of activities are to be performed and generate intelligent suggestions to replace and/or swap selected activities. The prediction system 100 may also automatically input weather risk data that is determined by the system into other planning modules to reduce errors and inefficiencies that may occur when such data is transferred and/or inputted by other mechanisms.

In one embodiment, the prediction system 100 may be implemented as a module of a computing system or cloud-based service configured with planning applications and tools for project management and scheduling (e.g., Oracle Primavera). The prediction system 100 may also be an application that is used by other planning applications.

The prediction system 100 may be configured with a machine learning (ML) model 105 that is trained to predict weather conditions based on historical weather conditions and predict activities that are likely affected by the predicted weather conditions. A graphical user interface 110 may be configured to provide access to functions of the prediction system 110, receive input from a user, transmit input to the ML model 105, provide selectable options, and display information on a display device.

In one embodiment, a sequence of activities 115 is input to the prediction system and to the ML model 105. In the following examples, the activities are construction activities and the sequence of activities 115 forms part or all of a construction project. The sequence of activities 115 may include any number of activities, which have different activity types, that are to be performed during the project. Each activity includes an assigned time period to be performed (e.g., start date and end date) and location to be performed. The location may be identified in one or more different way by, for example, a street address, city/state/country, latitude and longitude coordinates, zip code, etc.). The location may be the same for the entire project or may include different locations for different activities. Each activity may also include other details, such as duration, relationships to other activities, and constraints. Activity details may also define characteristics for each activity that control how the activity is scheduled and how individual risks impact each activity.

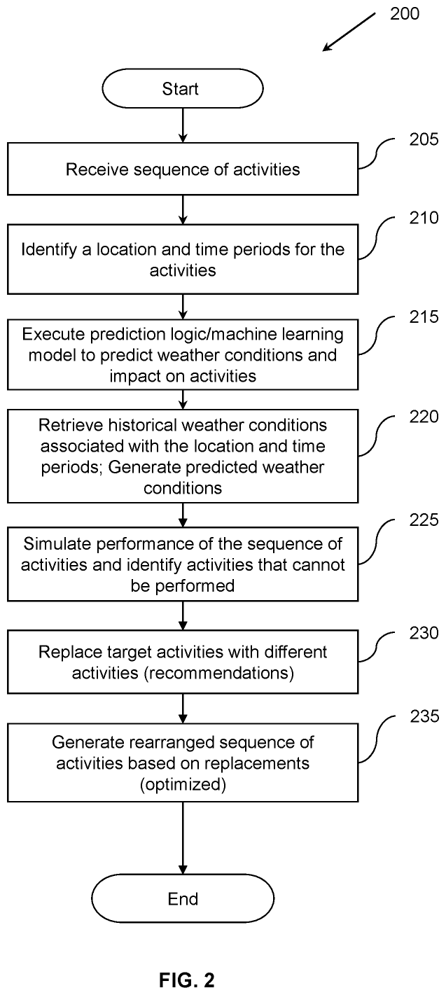

In one embodiment, the sequence of activities 115 may be defined as an initial schedule of the project. After the initial sequence of activities 115 is input to the prediction system 100, the system 100 automatically retrieves weather data associated with the location(s) and the time periods of the activities. Based on predicted weather risks and how the risks may impact the performance of certain activities, the prediction system 100 generates an optimized sequence 120. The optimized sequence 120 may include rearranged activities and/or recommendations for rearranging activities or swapping activities based at least on the predicted weather risks. Details of the system 100 are further described with reference to FIG. 2.

With reference to FIG. 2, one embodiment is illustrated of an operation of the prediction system 100.

At block 205, an initial sequence of construction activities is received by the prediction system 100, which may be loaded into memory. As previously stated, the sequence comprises a plurality of activities that are to be performed during a project. Each activity includes at least an assigned time period to be performed (e.g., start date and end date) and a location at which the activity is to be performed. In one embodiment, the sequence is configured as a data structure of entries that defines an initial schedule of activities. The initial schedule may be previously defined using a planning application or other type of application. Each activity may also include other associated data fields or tags that contain, for example, a unique identifier that identifies the activity, an activity type, past data types such as category tags and content tags, and/or other information that may be associated to the activity.

At block 210, the system identifies the location and time period(s) for performing the activities in the sequence. For example, each activity is identified from the sequence (e.g., from the entries in the memory) and for a given activity, its assigned location and time period are identified. In one embodiment, the sequence of activities may be configured to have one assigned location that applies to all activities rather than assigning a location to each activity. The location and time periods are then used to retrieve and automatically input weather data as described below.

At block 215, a machine learning (ML) model is executed that is trained to predict weather conditions based on historical weather conditions and to predict activities that are likely affected by the predicted weather conditions. In one embodiment, the machine learning (ML) model may incorporate a weather predicting algorithm and be trained with historical construction project data. For example, the ML model may receive historical data from previous projects that includes project type, project size, a sequence/schedule of activities, location and time periods of the activities. The historical project data may also include data describing weather data at that time and which activities were delayed, the length of the delays, reasons for the delays including weather conditions, and/or a number of non-working days for each month in previous years caused by local weather conditions. The ML model may then learn prior failure patterns in other projects and provide better solutions on the next schedule to predict which activities and/or activity types are most likely impacted by certain weather conditions.

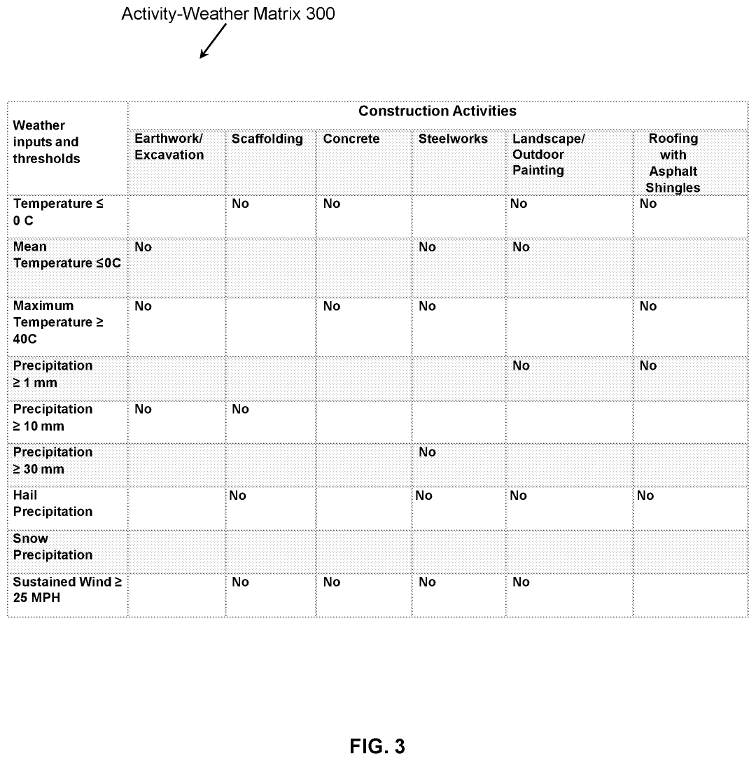

In another embodiment, an activity database 125 (see FIG. 1) including weather inputs and thresholds is created from the historical data and observed patterns. For example, the activity database may be configured as an activity-weather matrix 300 (see FIG. 3). The activity-weather matrix 300 maps construction activities (e.g., as columns) to weather conditions (e.g., as rows) that have associated condition thresholds. The example matrix is not limited to the shown entries and may include any combination of activities and weather inputs.

The activity-weather matrix 300 indicates whether each activity can and/or cannot be performed when a condition threshold is met for different weather inputs. In one embodiment, the activity-weather matrix 300 may be used by the ML model to identify activities that are at risk for delays or cannot be performed during certain weather conditions. For example, as shown in FIG. 3, the matrix 300 indicates that activity “Scaffolding” cannot be performed (e.g., value “No”) when the weather input “Temperature” meets a condition threshold “Temperature <=0 Celsius”. Blank values or no values indicate the activity can be performed. Other values may be used to reflect whether an activity can be or cannot be performed (e.g., 1 or 0, Yes or No, etc.).

With reference again to FIG. 2, at block 220, historical weather conditions are retrieved that are associated with the location and the time periods for the activities in the sequence. In one embodiment, the system 100 is configured to establish a network communication to a weather service or weather data website and request the historical weather conditions associated with the location and the same time of year as the time period(s) of the activities. In another embodiment, the historical weather data may be retrieved using a web crawler that accesses various weather related websites and extracts the weather data from web pages. The web crawler may be configured as an automated script with a list of URLs to access and search for historical weather data/conditions associated with the desired location and time periods. Based on the historical weather data, the ML model generates predicted weather conditions for the time periods of the activities.

At block 225, using the predicted weather conditions, the machine learning model may simulate a performance of the sequence of construction activities based on the predicted weather conditions. The predicted weather conditions for each time period may include various predictions for temperature, precipitation, snow, wind, wind gusts, water temperature, etc. The ML model may then identify one or more target activities (e.g., having a performance risk) in the sequence that cannot be performed during the predicted weather conditions that will occur during the time period of the target activities.

For example, the ML model may predict bad weather days based at least on the predicted weather conditions. The predicted bad weather days may then be mapped to the activities in the sequence that are assigned to be performed during the predicted bad weather days. The ML model may then identify the one or more target activities (i) that have a target activity time period corresponding to one or more of the predicted bad weather days and (ii) that likely cannot be performed during the one or more predicted bad weather days.

In another embodiment, the prediction system 100 may also estimate or predict non-working days (non-working time periods) based on weather event modeling that uses the historical weather data from the location of the activities, and the time of year in which the activities will be performed. Non-working days also may include holidays and other scheduled days-off. When a certain number of non-working days (as well as bad weather days) overlap with an activity's time period, that may trigger the ML model to identify the activity as a target activity that has a weather performance risk.

The non-working times may be combined with or associated to predicted weather risky days, which may also be classified as non-working days. The non-working days may then be assigned to the activities that may be impacted by the non-working days during the risk analysis.

In another embodiment, the simulation may be implemented by

predicting one or more target activities that cannot be performed during their assigned time period due to the predicted weather conditions of that time period. The system predicts the one or more target activities based on the activity-weather matrix 300. For each activity in the sequence, the predicted weather conditions and the activity type are input to the matrix 300 to determine if the activity can or cannot be performed under the predicted weather conditions. If the activity cannot be performed, then the activity is identified as a target activity (e.g., a weather risk activity that should be rescheduled).

At block 230, the machine learning model identifies replacement activities for the one or more target activities. A replacement activity includes a different activity from the same sequence of construction activities that can be performed during the time period of the target activity and during the predicted weather conditions at that time. For example, if an activity of “outdoor painting” is scheduled for March 1 to March 4 but the predicted weather conditions indicate that the activity cannot be performed (or significantly delayed), the ML model may identify a replacement activity “indoor painting” that can be performed during the time period March 1 to March 4.

The ML model can iteratively analyze the activities in the sequence to identify replacement/alternate activities and/or recommendations for replacing activities in order to optimize the performance of the sequence and thus optimize the project by at least reducing the predicted time delays. A target activity may be swapped with its replacement activity (e.g., time periods are swapped) in the sequence. A target activity may also be reassigned or moved to a different time period where the target activity can be performed during the predicted weather conditions of that time period.

At block 235, the machine learning model generates recommendations and a rearranged sequence of the construction activities based on the replaced activities and reassigned target activities. The rearranged sequence becomes the optimized sequence 120 (shown in FIG. 1) and may be visually displayed on the graphical user interface 110. In one embodiment, one or more recommendations to replace the one or more target activities in the sequence are generated and displayed on the graphical user interface 110.

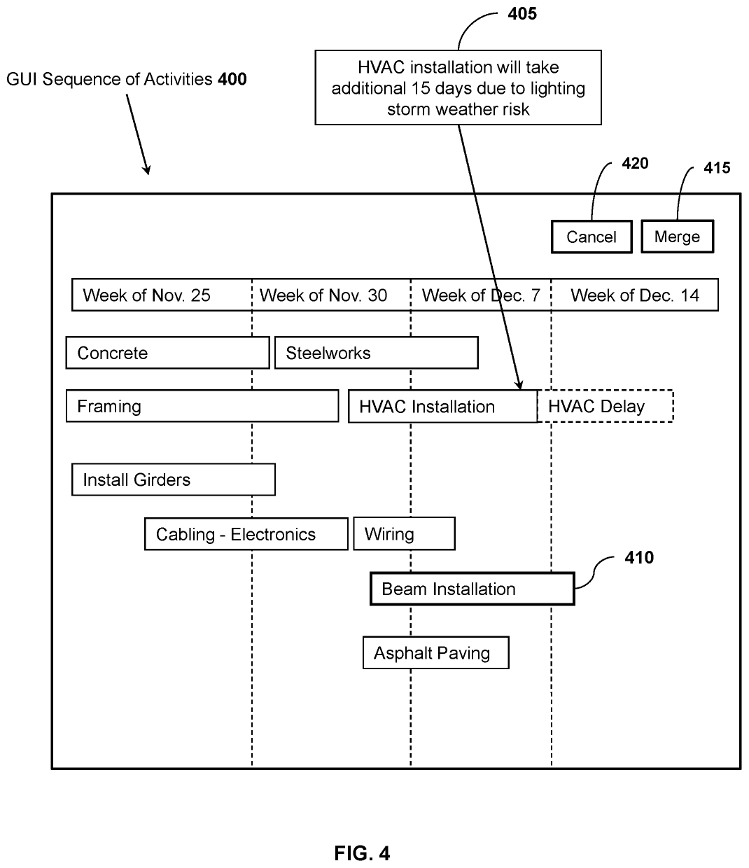

For example, FIG. 4 illustrates an embodiment of a graphical user interface 400 showing a visual sequence of activities and a recommendation for replacing an activity. The “sequence” of activities includes a time-based order of performance but may include two or more activities that overlap and/or are performed during the same time period in the sequence. For example, the activities of concrete, framing, installing girders, and cabling are all performed (at least partially) during the week of Nov. 25 in the sequence of activities 400.

In FIG. 4, the activity “HVAC Installation” was identified as a target activity subject to a predicted weather risk. The prediction system 100 may generate and display a warning message 405 regarding the prediction (e.g., “HVAC installation will take additional 15 days due to lighting storm weather risk”). A replacement activity may also be displayed in the visual sequence, for example, the activity “Beam installation” 410.

In one embodiment, selectable options may be provided on the graphical user interface 400 to accept or decline any one of the recommendations or replacement activities that replaces a target activity in the rearranged sequence. A user may then choose to accept (e.g., merge button 415) or decline (e.g., cancel button 420) the recommendations shown in the rearranged sequence.15

In this manner, the present system implements a risk analysis that combines the timing of the predicted weather risks with the timing of the activities that are affected by uncertainty and other risks.

The construction process is one that includes considerable risks. One of the greatest areas of risk is time and the associated costs of delay. Any successful project requires that the risks associated with time are well managed. By understanding the existing risks and planning for these by properly modeling them in a project schedule, any potential costly risks can be minimized and controlled.

As described above, one such risk is a weather risk and the present system implements a novel technique to address weather risk that causes activities to be delayed by non-working periods.

### Intelligent Digital Construction Schedule Embodiment

In another embodiment, the prediction system 100 may be implemented

with one or more of the following features, which may be combined with one or more of the features of FIGS. 1-4.

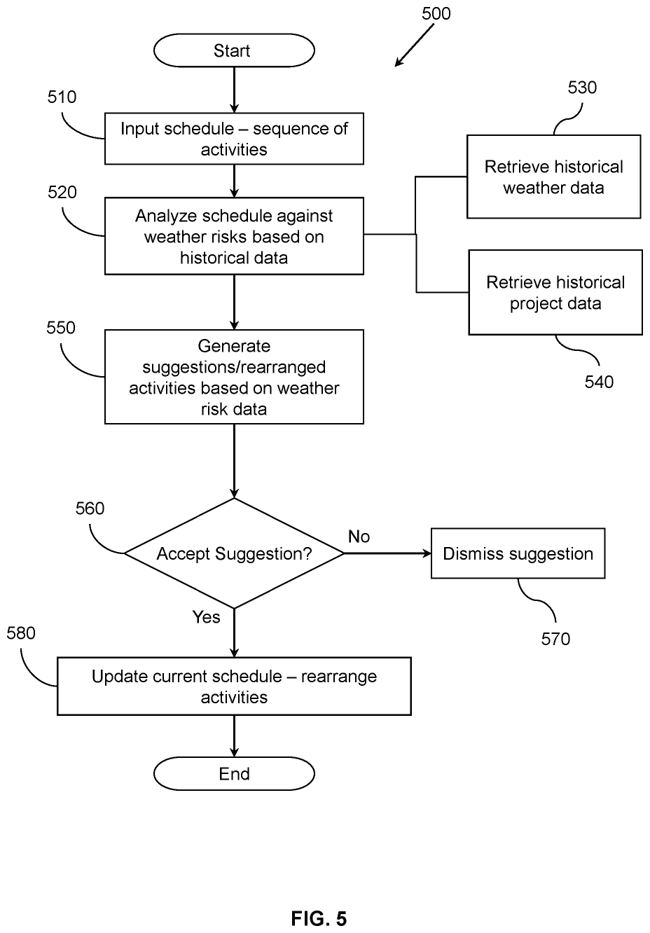

With reference to FIG. 5, the prediction system 100 may be configured to predict weather risks and generate suggestions for an intelligent digital construction schedule that reduces errors and inefficiencies by adopting the features of method 500.

At block 510, a user may sign into the system. To analyze and determine predictions for a project, the prediction system 100 is provided with a sequence of construction activities as previously described. These activities maybe identified by unique IDs, past data types such as category tags and content tags.

For receiving additional input data for the project and/or to create the sequence of activities, a project detail page may be generated on a graphical user interface for receiving project location and date information from the user. Location coordinates are captured by the system. The location and date information allows the system to determine non-working days in a given month (e.g., holidays, Saturdays, Sundays).

At block 520, the system analyzes the schedule against weather risks based on historical data. For example, the system may retrieve historical weather data (block 530) by being subscribed with location specific local weather and time of year making the weather data automatically available to predict additional non-working days that may be caused by weather. For example, in the month of January in any typical year, there are 15 non-working days in Shetland, UK, which include non-working days caused by predicted weather conditions. These dates can be spread across the time period.

At block 540, the system may also identify and retrieve historical project data from previous projections with similar size, similar activities, similar locations, and/or similar time periods. Current and past activities can be compared to determine similar activities that were delayed in the past due to weather conditions occurring at similar time periods in the sequence of activities.

From the historical weather data and historical project data, three (3) point estimates identifying a number of non-working days (Most likely number of non-working days, Minimum days, Maximum non-working days) may be captured from historical project data from the same location and time period. The present system automates the process of entering the weather risk data at a given location.

A weather modeling module may be configured to allow a user to define risk assessments for weather conditions in a project/sequence of activities and include these uncertain weather conditions in the risk analysis. The risk analysis correctly combines the timing of the weather risks with the timing of the activities that are affected by uncertainty and other risks.

In one embodiment, the system 100 may include a risk register configured as a central repository for project or activity risk data. The risk register functions to provide a view of the current status of each of the main risks faced by the project or the activities.

System is provided with logic for weather inputs (e.g., temperature, wind, etc.) and threshold conditions that causes non-working days, and their impact on a specific activity. In one embodiment, this includes the activity-weather matrix 300 (FIG. 3) as previously described.

Using the project location and the activity-weather matrix 300 (FIG. 3), the system determines and populates the non-working time estimates to the specific weather risks. Mapping bad weather days to the activities that cannot be performed during a specific period under the predicted bad weather conditions.

At block 550, the system generates suggestions and/or a rearranged schedule based on the predicted risks of weather and other non-working days. This include identifying one or more target activities that are impacted by the predicted weather risks as previously described.

At block 560, selectable options are provided on the graphical user interface to accept or cancel the suggestions. In response to a cancel option being selected, the suggestion is dismissed (block 570) and the schedule/sequence of activities is not modified by the suggestion.

In response to an accept option being selected, the process moves to block 580 and the schedule is updated and/or the activities are rearranged based on the suggestions.

Additional details of the above blocks may include the following.

In one embodiment, the prediction system 100 may be integrated with qualitative and quantitative risk analysis capabilities for projects to help determine the impact of risk and uncertainty on projects. The system is configured to help identify and prioritize potential threats and opportunities that exist for a project.

A “location” is a geographical reference defined by a pair of coordinates; longitude and latitude. To create a location, coordinates may be entered directly, or a street address may be entered that causes the system to fetch the longitude and latitude. Locations can be assigned to projects or risks to produce reports based on geographical location.

A risk management process may include both the identification of potential risks and the evaluation of the potential impact of the risk. For risk identification, risks are added to the risk register and the risk's characteristics.

Risks specific to a particular project may be added as project risks. Risks can be a threat or opportunity to the projects. Examples of opportunities may include a local change in policy that could benefit the project or, new technology or equipment that could save time to complete a project.

The system may be configured to allow users to assign probability and impact values based on the risk assessment criteria defined for the project. Using the criteria, risks may be prioritized. From this prioritization, a list of the most important risks that can be further analyzed to understand the severity of their potential impact to the project, and the time frame when the impact will occur.

As previously described, a project can be impacted by a variety of weather-specific risks depending on the project's geographic location and the current season. The weather risks may include high winds, excessive wave height, flooding, and frozen water bodies. These events can lead to periods of time where construction activities cannot be performed, thereby threatening finish dates and costs of individual activities and the project as a whole. Weather risk modeling can be used to estimate periods of non-working time caused by weather events. The weather risk data may be created in a risk register and used in the risk analysis, enabling the user to understand its potential impact on the project's schedule and cost. For each risk, different weather periods and non-working estimates are defined and predicted to model how the risk's impact may change over time.

Non-working time estimates may be entered as a distributed range of days or as a percentage of non-working days within the weather period. Non-work percentage values may be further enhanced by estimating the percentage of non-working days immediately following another non-working day, a weather modeling concept known as persistence. These inputs are from the location, time of the year, and similar historical project data from a product database.

In one embodiment, a method for accurately estimating non-working time is to reference historical weather data for the type of weather event modeling, the location of the project activities, and the time of year in which the activities will be performed. After a weather risk is created, they are assigned to the activities that may be impacted by the weather risk. The non-working time estimates captured by each risk are applied to associated activities during the risk analysis. The weather risks without activity assignments are not included in risk analysis calculations.

Type of Weather Conditions that Impact Activities

In one embodiment, an activity database may be created as matrix of construction activities and weather inputs and thresholds. One example is the activity-weather matrix 300 shown in FIG. 3. When a new project is created with a set of activities and a location, the prediction system 100 accesses the activity-weather matrix 300 to identify matching activities and check any associated weather condition thresholds that impact the activity.

Example weather inputs and threshold conditions may include: Wind speed values, temperature values, humidity values, rainfall (heavy rainfall preventing exterior work and waiting for a drying out period), Wave Height (wave heights exceed a certain size in winter months prevent use of a barge for off-shore work). Lightening can result in the project being temporarily shut down and a direct lightning strike on an item of equipment causes damage which is costly to repair and delays the project. Lightening can start fires and partly completed structures could be burned down. Storms/Hurricanes/Cyclones—Causes damage to the project site, stops work during the event and usually stops the project several days before the storm strikes so the project can be made storm ready. Hot Weather causes equipment heat output and hot weather affects construction workers more easily than indoor office workers.

The activity-weather matrix 300 may be configured with any number of different types of activities. Example construction activities may be grouped by type of activity or category. For example, three general categories that may cover a majority of activities may include structural activities, finishing activities, and installation activities. Structural activities may include activities related to site marking, excavations, concrete activities, applying reinforcing steel, form works, structural concrete, roofing, scaffolding, and other structural related tasks. Finishing activities may include activities related to outdoor painting, plastering, doors and windows, partitions and cladding, indoor painting, ceilings, floors, moldings, and other types of finishing related tasks. Installation activities may include activities related to electrical works, furnishing and fixture installations, plumbing, heating and cooling, and other types of installations that may be performed. Each one of these activities may be assigned in the matrix certain weather condition thresholds where the activity can or cannot be performed when the condition threshold exists.

Estimated non-working days may be visually displayed as a distribution Shape. This shape is a probability distribution that best models the estimates for non-working days in the period. Types of distribution shapes include Triangle (type of probability with Min days, Max days, Most likely non-working days) and Uniform (type of probability distribution in which all outcomes are equally likely).

Minimum Days is the minimum number of non-working days in the period. Most Likely Days is the most likely number of non-working days in the period (this is used in the Triangle shape). Maximum Days is the maximum number of non-working days in the period. Non-Working Persistence is the probability of a non-working day following another non-working day in the period.

Non-Working Time Uncertainty Example: Wind Speeds:

Seasons that stop activities from continuing. Historical data is used to determine probability of non-working time. For example, Shetland, UK project location in January: there are historically 5 to 10 days when wind speed goes beyond the operating rate and work cannot take place. Winds exceeding 30 mph preventing use of tower cranes on-site. Heavy rainfall prevents exterior work and waiting for a drying out period. Wave heights exceed a certain size in winter months prevent use of a barge for off-shore work.

Non-Working Events Example: Hurricanes:

Electricity outages can occur 5 or 6 times a year in certain regions and can mean no use of electrical equipment and inadequate lighting for 1-2 days at a time. Hurricanes might impact work site causing a period of downtime. Input data may include time period(s) of hurricanes, frequency (occurrences per period) as a distribution, and impact duration per occurrence as a distribution.

Non-Working Periods Example: Frozen Lakes and Canals:

Periods of non-working time (or working time) with uncertain start and finish dates. A sea or canal often freezes for part of the winter preventing ships bringing materials on-site (or shipments off-site).

In one embodiment, quantitative risk analysis is a way of numerically estimating the probability that a project will meet its cost and time objectives. Quantitative risk analysis also helps pinpoint where the biggest risk exposure lies and when in the project schedule it is most likely to occur.

The weather risks predicted by the prediction system 100 may be supported by a quantitative risk analysis and used to simulate non-working time for individual activities in the sequence/schedule. In one embodiment, the prediction system 100 uses a Monte Carlo method to perform the quantitative risk analysis during simulation in block 225 of FIG. 2. Monte Carlo is a probabilistic simulation modeling technique to generate multiple runs simulating real project progress. During the analysis, the system uses varied combinations of input variables to build its model, including project schedule, risk, and cost data within their statistical constraints. Each simulation iteration generates a duration for each project activity, taking into account its associated risks, weather-related non-working estimates, and general uncertainty. The system 100 may also record all project schedules and critical paths during progress to calculate the many possible project completion dates and project costs.

Schedule impact values are distributed to all activities that are assigned to a weather risk. Impact values may be based on a severity score (e.g., high, average, low). If no activities are assigned to a threat or opportunity risk, the schedule impact values affect the project directly. This means that during the quantitative risk analysis, the duration of the schedule impact is added directly to the project finish using the project calendar. If multiple risks impact the project directly, the schedule impacts are added to the project cumulatively

For the weather risks, non-working time estimates are combined with each associated activity's assigned calendar, representing exception time in which the activity is not worked. This simulates the impact a weather event can have on the duration and finish date of an activity, which also indirectly impacts the total cost of the activity. If no activities are assigned to a weather risk, it is not included in the quantitative risk analysis.

The results of the Monte Carlo analysis are statistical distributions of cost and schedule estimates for the entire project. The analysis also produces statistical distributions of schedule estimates for individual activities. Based on the calculated distributions, it is possible to determine the likelihood that the project or an activity will be completed on a certain date. It may also determine the likelihood that the project will be completed within a certain cost. The Monte Carlo analysis may also produce a list of the risks that most critically affect (positively or negatively) the finish date and cost of the project in the form of tornado charts.

### Control Risks

After analyzing and understanding the impact that identified risks pose to the activities or project, risk response actions are aimed at mitigating the effects of the risks. Risk response planning enables a user to identify and document actions they might take to alleviate the impact of an identified risk. One can also define post-response probability and impact values to illustrate how risk response planning can mitigate the impact of a risk, establishing a post-response context. For projects, a risk analysis may be executed against post-response context to examine the effectiveness of a risk response plan. A user may define response actions on weather risks to minimize the impact of specific weather events in the project.

### Probabilistic Weather Calendar

In one embodiment, after the weather periods are added and non-working time is estimated to the weather risks, a probabilistic weather calendar may be generated and displayed on the graphical user interface. This allows a user to ensure that each risk's weather data accurately models the corresponding weather event.

Non-working probabilities are calculated and displayed in the probabilistic weather calendar for each weather risk. The probabilistic weather calendar may run a simulation of X-number of iterations using the risk's period and estimate data. It then displays the non-working probabilities for each day that occurs in the risk's periods. The calendar is intended to be a visual confirmation that weather data is being estimated as expected. The time period dates and non-working time estimates may be revised and run the simulation again.

With the present systems and methods, weather modeling data generated by the risk analysis can be used to make more informed decisions during a project's planning phase. Consider the potential severity of each risk when developing strategies to reduce its impact on a project schedule. For example, users may choose to schedule activities that could be severely impacted by rain to occur outside of the rainy season. In locations and seasons with higher likelihood of flooding, recommendations may be generated to implement additional safety measures to protect a work site. If weather may affect the timeliness of material deliveries, recommendations may be generated to consider reaching out to an alternate supplier. Users can keep track of potential strategies by adding them as response actions to each risk.

Thus, present systems and methods implement an intelligent digital construction schedule suggestion tool. This reduces error and inefficiencies by automating the process of entering project weather data in a risk register for a given location and then suggesting an optimized construction schedule. This design can be applied to any kind of construction project and in any location.

### Cloud or Enterprise Embodiments

In one embodiment, the prediction system 100 is a computing/data processing system including an application or collection of distributed applications for enterprise organizations. The applications and prediction system 100 may be configured to operate with or be implemented as a cloud-based networking system, a software as a service (SaaS) architecture, or other type of networked computing solution. In one embodiment the prediction system 100 is integrated with a centralized server-side application that provides at least the functions disclosed herein and that is accessed by many users via computing devices/terminals communicating with a computing system (functioning as the server) over a computer network.

In one embodiment, one or more of the components described herein are configured as program modules stored in a non-transitory computer readable medium. The program modules are configured with stored instructions that when executed by at least a processor cause the computing device to perform the corresponding function(s) as described herein.

### Computing Device Embodiment

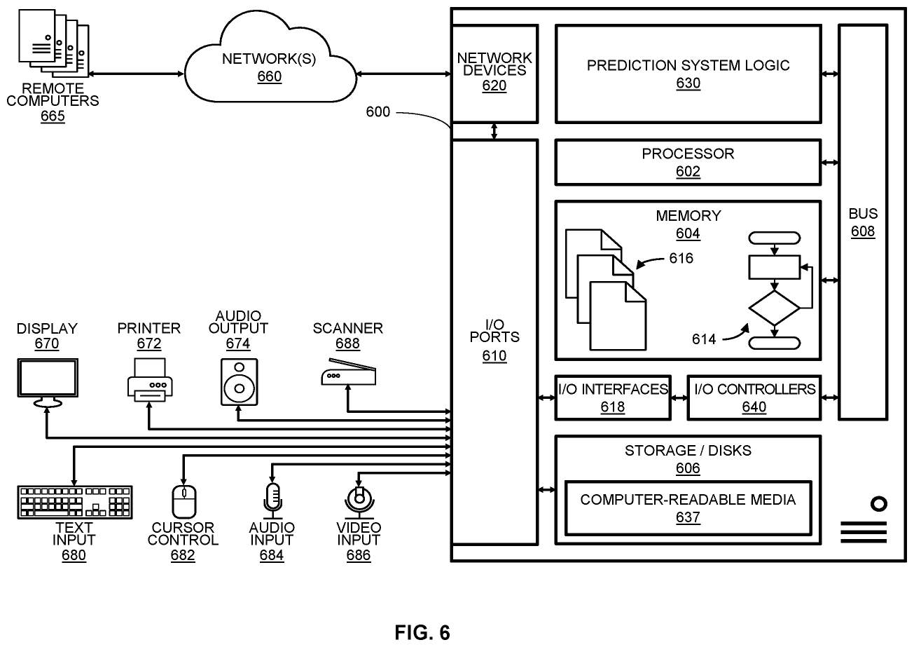

FIG. 6 illustrates an example computing device that is configured and/or

programmed as a special purpose computing device with one or more of the example systems and methods described herein, and/or equivalents. The example computing device may be a computer 600 that includes at least one hardware processor 602, a memory 604, and input/output ports 610 operably connected by a bus 608. In one example, the computer 600 may include prediction system logic 630 configured to facilitate the prediction system 100 shown in any one of FIGS. 1-5.

In different examples, the logic 630 may be implemented in hardware, a non-transitory computer-readable medium 637 with stored instructions, firmware, and/or combinations thereof. While the logic 630 is illustrated as a hardware component attached to the bus 608, it is to be appreciated that in other embodiments, the logic 630 could be implemented in the processor 602, stored in memory 604, or stored in disk 606.

In one embodiment, logic 630 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to implement functions of the prediction system 100. The means may also be implemented as stored computer executable instructions that are presented to computer 600 as data 616 that are temporarily stored in memory 604 and then executed by processor 602.

Logic 630 may also provide means (e.g., hardware, non-transitory computer-readable medium that stores executable instructions, firmware) for performing functions of the prediction system 100.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A storage disk 606 may be operably connected to the computer 600 via, for example, an input/output (I/O) interface (e.g., card, device) 618 and an input/output port 610 that are controlled by at least an input/output (I/O) controller 640. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The computer 600 may interact with, control, and/or be controlled by input/output (I/O) devices via the input/output (I/O) controller 640, the I/O interfaces 618, and the input/output ports 610. Input/output devices may include, for example, one or more displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 606, network devices 620, and so on. The input/output ports 610 may include, for example, serial ports, parallel ports, and USB ports.

The computer 600 can operate in a network environment and thus may be connected to the network devices 620 via the I/O interfaces 618, and/or the I/O ports 610. Through the network devices 620, the computer 600 may interact with a network 660. Through the network, the computer 600 may be logically connected to remote computers 665. Networks with which the computer 600 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternate methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A method performed by a computing device including at least one processor and memory, the method comprising:
receiving, from the memory, a sequence of construction activities that comprises a plurality of activities;
identifying, by the computing device, a location and time periods for performing the plurality of activities;
executing a machine learning model that is trained to predict weather conditions based on historical weather conditions and predict activities that are likely affected by the predicted weather conditions;
retrieving historical weather conditions that are associated with the location and the time periods for the plurality of activities, and generating predicted weather conditions for the time periods;
simulating, by the machine learning model, a performance of the sequence of construction activities and identifying one or more target activities that cannot be performed during the predicted weather conditions;
replacing, by the machine learning model, the one or more target activities with different activities from the sequence of construction activities that can be performed during the predicted weather conditions; and
generating, by the machine learning model, a rearranged sequence of the construction activities based on the replacing.

2. The method of claim 1, wherein the simulating comprises:
determining, by the machine learning model, for a given activity in the sequence of construction activities, an activity type and an activity time period that has been assigned for performing the given activity;
mapping, by the machine learning model, predicted bad weather days including predicted weather conditions to the activities in the sequence that are assigned to be performed during the predicted bad weather days;
identifying, by the machine learning model, the one or more target activities having a target activity time period that likely cannot be performed during the predicted weather conditions that are mapped to the target activity time period; and
generating a recommendation to replace the one or more target activities in the sequence with an alternate activity in the sequence that can be performed during the predicted weather conditions and during the target activity time period.

3. The method of claim 1, wherein the simulating further comprises:
accessing an activity database that includes risk data that identifies activities that cannot be performed during defined weather conditions; and
identifying the one or more target activities from the sequence that match an activity from the activity database that cannot be performed during the defined weather conditions.

4. The method of claim 1, wherein the machine learning model further performs:
estimating non-working times during the time period for performing the sequence of construction activities, wherein the non-working times are combined with at least the predicted weather conditions and the location for performing the sequence of construction activities.

5. The method of claim 1, further comprising:
generating an activity-weather matrix of construction activities mapped to weather conditions that have associated condition thresholds, wherein the activity-weather matrix indicates whether an associated activity cannot be performed when a condition threshold is met.

6. The method of claim 1, further comprising:
identifying historical project data that corresponds to previous construction projects that are similar to the target construction project; and
determine similar activities that were delayed due to weather conditions occurring at similar time periods in the sequence of activities.

7. The method of claim 1, further comprising:
in response to generating the rearranged sequence, visually displaying the rearranged sequence on a graphical user interface as a recommendation; and
providing a selectable option on the graphical user interface to accept or decline the different activities that replaced the one or more target activities in the rearranged sequence.

8. The method of claim 1, wherein in response to identifying, by the computing device, the location and the time periods for performing the plurality of activities, the method further comprising:
retrieving, by the computing device, the historical weather conditions that occurred at the location and corresponding to the same time periods during previous years; and
automatically inputting, by the computing device, the historical weather conditions into the machine learning model.

9. A non-transitory computer-readable medium that includes stored thereon computer-executable instructions that when executed by at least a processor of a computer cause the computer to:
receive, from a memory, a sequence of construction activities that comprises a plurality of activities;
identify, by the processor, a location and time periods for performing the plurality of activities;
execute a machine learning model that is trained to predict weather conditions based on historical weather conditions and predict activities that are likely affected by the predicted weather conditions;
retrieve historical weather conditions that are associated with the location and the time periods for the plurality of activities, and generating predicted weather conditions for the time periods;
simulate, by the machine learning model, a performance of the sequence of construction activities and identifying one or more target activities that cannot be performed during the predicted weather conditions;
replace, by the machine learning model, the one or more target activities with different activities from the sequence of construction activities that can be performed during the predicted weather conditions; and
generate, by the machine learning model, a rearranged sequence of the construction activities based on the replacing.

10. The non-transitory computer-readable medium of claim 9, further comprising instructions that when executed by at least the processor cause the processor to:
determine, by the machine learning model, for a given activity in the sequence of construction activities, an activity type and an activity time period that has been assigned for performing the given activity;
map, by the machine learning model, predicted bad weather days including predicted weather conditions to the activities in the sequence that are assigned to be performed during the predicted bad weather days;
identify, by the machine learning model, the one or more target activities having a target activity time period that likely cannot be performed during the predicted weather conditions that are mapped to the target activity time period; and
generate a recommendation to replace the one or more target activities in the sequence with an alternate activity in the sequence that can be performed during the predicted weather conditions and during the target activity time period.

11. The non-transitory computer-readable medium of claim 9, further comprising instructions that when executed by at least the processor of a computing device cause the processor to:
in response to identifying the location and the time periods for performing the plurality of activities:
retrieve, by the computing device, the historical weather conditions that occurred at the location and corresponding to the same time periods during previous years; and
automatically inputting, by the processor, the historical weather conditions into the machine learning model.

12. The non-transitory computer-readable medium of claim 9, further comprising instructions that when executed by at least the processor cause the processor to:
in response to generating the predicted weather conditions for the location and the time periods:
access, by the processor, an activity-weather matrix of construction activities to determine whether a selected activity from the sequence can be performed during a predicted weather condition;
wherein the activity-weather matrix maps the construction activities to weather conditions that have associated condition thresholds, and
wherein the activity-weather matrix indicates whether an associated activity cannot be performed when a condition threshold is met.

13. The non-transitory computer-readable medium of claim 9, further comprising instructions that when executed by at least the processor cause the processor to:
estimate non-working times during the time period for performing the sequence of construction activities, wherein the non-working times are based on at least the historical weather conditions and the location for performing the sequence of construction activities.

14. The non-transitory computer-readable medium of claim 9, wherein the instructions to in response to generate the rearranged sequence further comprising instructions that when executed by at least the processor cause the processor to:
visually display the rearranged sequence on a graphical user interface as a recommendation; and
provide a selectable option on the graphical user interface to accept or decline the different activities that replaced the one or more target activities in the rearranged sequence.

15. A computing system, comprising:
at least one processor connected to at least one memory;
a non-transitory computer readable medium including instructions stored thereon that when executed by at least the processor cause the processor to:
receive, from the at least one memory, a sequence of activities that comprises a plurality of activities;
identify, by the computing device, a location and time periods that are assigned for performing each activity in the sequence of activities;
retrieve historical weather conditions that are associated with the location and the time periods for the plurality of activities;
generate predicted weather conditions for the location and the time periods based on the historical weather conditions;
predict one or more target activities that cannot be performed during their assigned time period and during the predicted weather conditions;
wherein the one or more target activities are predicted based on an activity-weather matrix of activity types mapped to weather conditions that have associated condition thresholds that indicate whether an associated activity type cannot be performed when a condition threshold is met;
replace, by the processor, the one or more target activities with different activities from the sequence of activities that can be performed during the predicted weather conditions; and
generate, by the processor, a rearranged sequence of the activities based on the one or more target activities that are replaced.

16. The computing system of claim 15, wherein the instructions predict the one or more target activities further include instructions that when executed by at least the processor cause the processor to:
determine, for a given activity in the sequence of activities, an activity type and an activity time period that has been assigned for performing the given activity;
predict bad weather days based at least on the predicted weather conditions;
map the predicted bad weather days to the activities in the sequence that are assigned to be performed during the predicted bad weather days;
identify the one or more target activities (i) that have a target activity time period corresponding to one or more of the predicted bad weather days and (ii) that likely cannot be performed during the one or more predicted bad weather days; and
generate a recommendation to replace the one or more target activities in the sequence with a different activity in the sequence that can be performed during the one or more predicted bad weather days.

17. The computing system of claim 15, further comprising:
a machine learning model that is trained to predict weather conditions for a selected time period based on the historical weather conditions and predict activities that are likely affected by the predicted weather conditions;
wherein the machine learning model is configured to predict the one or more target activities that cannot be performed during their assigned time period based on at least the predicted weather conditions and the activity-weather matrix.

18. The computing system of claim 15, further comprising:
a machine learning model that is trained to predict weather conditions based on the historical weather conditions and predict activities that are likely affected by the predicted weather conditions; and
wherein the machine learning model is configured to simulate a performance of the sequence of activities and identify the one or more target activities that cannot be performed during the predicted weather conditions.

19. The computing system of claim 15,
wherein the activity-weather matrix is further configured to indicate whether an associated activity type can be performed during the weather conditions even when the condition threshold is met; and
wherein the computing system is configured to replace the one or more target activities by identifying the different activities from the sequence of activities based on the activity-weather matrix.

20. The computing system of claim 15, wherein the computing system is further configured to:
in response to generating the rearranged sequence, visually display the rearranged sequence on a graphical user interface as a recommendation; and
provide a selectable option on the graphical user interface to accept or decline the different activities that replaced the one or more target activities in the rearranged sequence.
